(19) United States
(12) Patent Application Publication
(10) Pub. No.: US 2017/0231241 A1
(43) Pub. Date: Aug. 17, 2017

(54) DAIRY PRODUCT WITH STRAWBERRY

(71) Applicant: COMPAGNIE GERVAIS DANONE, Paris (FR)

(72) Inventors: Marc BEVERINI, Chatenay Malabry (FR); Alexandra DIMITRIADES, Sainte Geneviève des Bois (FR); Chantal LAMICHE, Verrières Le Buisson (FR); Jean-François PELLETIER, Hyères (FR); Mark SPRINGETT, Limours (FR); Rémi PORTIER, Epinay-sur-Orge (FR)

(73) Assignee: COMPAGNIE GERVAIS DANONE, Paris (FR)

(21) Appl. No.: 15/329,800

(22) PCT Filed: Jul. 30, 2015
(86) PCT No.: PCT/EP2015/067604

§ 371 Date: Jan. 27, 2017

(30) Foreign Application Priority Data
Jul. 30, 2014 (IB) PCT/IB2014/001847

(51) Int. Cl. A23C 9/156; A23C 9/133; A23L 5/43

(52) U.S. Cl. CPC A23C 9/156; A23L 5/43; A23C 9/133; A23V 2002/00

(57) ABSTRACT

The invention relates to dairy products with strawberry having specific anthocyanins profiles that allow color-related improvements.

The invention relates to dairy products with strawberry having specific anthocyanins profiles that allow color-related improvements.

Dairy products with strawberry are appreciated by consumers. Strawberries have a red coloration, and consumers expect dairy product to have a red coloration as a signal of the presence of strawberry. Thus some red coloration is expected by consumers, and the consumer has expectations related to the color of a dairy product comprising strawberry.

Strawberry varieties that are commonly used in dairy products include Camarossa and Camino Real. Upon processing and introduction in dairy products, the coloration initially present in strawberries is modified, for example with a loss of chroma (for a given color a higher chroma corresponds to being brighter, a lower chroma corresponds to being duller). To obviate this, dairy products with strawberries, for example with Camarossa and Camino Real varieties, often contain colorants. Colorants are not perceived as natural by some consumers. Additionally their use leads to additional costs and/or formulation complexity. There is thus a need for products comprising less colorant or being substantially free of colorant. Another route to compensate color modifications is to increase the amount of strawberry. This route is however expensive, and might lead to less affordable products.

There is a need for solutions which allow an improvement of the efficiency of coloration of strawberry in dairy products, for example which improve chroma. There is for example a need for obtaining a same level of coloration, preferably chroma, with lower amounts of strawberry, and/or for obtaining an increased coloration, preferably chroma, with an identical amount of strawberry, and/or for obtaining a same level of coloration, preferably chroma, with lower amounts of colorants (down to zero preferably), and/or for obtaining an increased coloration, preferably chroma, with an identical amount of colorant.

The invention addresses at least one of the problems or needs above with a dairy product comprising some strawberry having anthocyanins comprising the following three specific anthocyanins:
A1: Cyanidin-3-Glucosid (Cy3G),
A2: Pelargonidin-3-Glucosid (Pg3G), and
A3: Pelargonidin-3-Malonylglucosid (Pg3MG),
   wherein the weight ratio A3/(A1+A2+A3) is at least 0.20, preferably at least 0.25, preferably at least 0.30.

The invention also concerns a process for making the product. The invention also concerns the use of the strawberry in dairy products, preferably for improving coloration, preferably chroma.

### Definitions

In the present application, unless provided otherwise, all concentrations, amounts, or proportions are provided by weight.

In the present application a colorant refers to a compound or composition of matter, different from a fruit, added to a product or an intermediate thereof to provide a coloration modification. Colorants are known by the one skilled in the art. They are typically labeled on dairy fermented products. Colorants are for example listed on European directive 94/36/EC. Some colorants are identified by E numbers starting with 1, for example E1xx. Examples of colorants include carmine, and natural coloring foodstuff such as blackcarrot, beetroot, elderberry juice, or extracts thereof.

In the present application a product “substantially free of colorant” refers to a product that does not comprise significant amounts of colorant. The amount might depend on the very colorant considered. The amount by weight is typically of lower than 1%, preferably lower than 0.1%, preferably lower than 0.01%, preferably lower than 0.001%, preferably lower than 1 ppm, preferably lower than 0.1 ppm, preferably lower than 0.01 ppm, preferably none. By “substantially free of colorant” it is preferably meant that no colorant is added and/or that the presence of such compounds is not labeled.

### Strawberries

The strawberry used in the dairy product of the invention (said strawberries being also referred to herein as “strawberry of the invention”) comprises anthocyanins.

Such compounds are glycosides of anthocyanidins, typically 3-glycosides. They are known and have been well described. The strawberry of the invention comprises the three following anthocyanins, also referred to “main anthocyanins”:
A1: Cyanidin-3-Glucosid (Cy3G),
A2: Pelargonidin-3-Glucosid (Pg3G), and
A3: Pelargonidin-3-Malonylglucosid (Pg3MG).

In the strawberry of the invention the weight ratio A3/(A1+A2+A3) is at least 0.20, preferably at least 0.25, preferably at least 0.30. This ratio represents the proportion by weight of anthocyanin A3 within the main anthocyanins.

In a preferred embodiment the weight ratio A3/A2 is of at least 0.15, preferably at least 0.5.

In a preferred embodiment the strawberry of the invention satisfies the following conditions:
weight ratio A1/(A1+A2+A3) is from higher than 0 to 0.1,
weight ratio A2/(A1 +A2+A3) is from 0.48 to 0.62,
weight ratio A3/(A1 +A2+A3) is from 0.25 to 0.5, and
the total of the weight ratios is 1.

In a preferred embodiment the strawberry has a total concentration of A1, A2 and A3 of at least 400 mg/kg (i.e. 1 kg of strawberry contains at least 400 mg of the main anthocyanins A1, A2 plus A3), preferably at least 500 mg/kg, preferably at least 600 mg/kg, preferably at least 700 mg/kg.

The ratios and amounts of A1, A2 and A3 can be determined by analysis of the strawberry. The analysis can be typically performed (preferably after extraction of anthocyanins with methanol) by a LC-PDA-MS analytical method , for example by high performance liquid chromatography (HPLC) coupled to photodiode array (PDA) and electrospray ionization mass spectrometry (Quattro Ultima Platinum—Waters) in positive ion mode (ESI+-MS). A detailled, preferred protocol is given in the examples.

Strawberries that can be used for the invention are available on the market. Strawberries are usually identified as varieties and/or by commercial names. Examples of appropriate varieties to be used as strawberries of the invention are Deep Ruby, DipRed, Rubydee, Rubinociv and/or Rubino, all available at Mazzoni. Appropriate varieties can be also or alternatively identified as varieties covered by and/or described in the following plants breeder's rights:
European Union application 20121736 filed Aug. 9 2012, and/or
European Union application 20121735 filed Aug. 9 2012.

The features of the strawberries of the invention, as to anthocyanins, can be determined or measured before use introduction in the dairy product. If the strawberries do not meet the features, one can reject them and select strawberries, for example with a different maturity and/or that have been subject to other climatic conditions upon growing, that meet the features. The features can be measured as averages and/or random picks on batch of strawberries.

It is mentioned that the features of a strawberry of the invention as to proportions of A1, A2 and A3, can be also understood as features to be determined on the dairy product, with appropriate analytical methods. If the dairy product presents these proportions, then the strawberry is considered as being a strawberry of the invention. The analysis can be typically performed (preferably after extraction of anthocyanins with methanol) by a LC-PDA-MS analytical method , for example by high performance liquid chromatography (HPLC) coupled to photodiode array (PDA) and electrospray ionization mass spectrometry (Quattro Ultima Platinum—Waters) in positive ion mode (ESI+-MS). A detailled, preferred protocol is given in the examples. Thus the dairy product of the invention typically has anthocyanins comprising the following three specific anthocyanins:
A1: Cyanidin-3-Glucosid (Cy3G),
A2: Pelargonidin-3-Glucosid (Pg3G), and
A3: Pelargonidin-3-Malonylglucosid (Pg3MG), wherein the weight ratio A3/(A1+A2+A3) is at least 0.20, preferably at least 0.25, preferably at least 0.30.

Preferably, in the dairy product the weight ratio A3/A2 is at least 0.15, preferably at least 0.5. Preferably the following conditions are satisfied in the dairy product:
weight ratio A1/(A1+A2+A3) is from higher than 0 to 0.1,
weight ratio A2/(A1+A2+A3) is from 0.48 to 0.62,
weight ratio A3/(A1+A2+A3) is from 0.25 to 0.5, and
the total of the weight ratios is 1.

In a preferred embodiment the dairy product has a total concentration of A1, A2 and A3 of at least 40 mg/kg, preferably at least 50 mg/kg, preferably at least 60 mg/kg, preferably at least 70 mg/kg.

It is mentioned that the strawberry of the invention might comprise further different anthocyanins or anthocyanidins. Such further anthocyanins or anthocyanidins, if present are typically each present in proportions (based on the total amount of anthocyanins and anthocyanidins) lower than the total proportions of A1, of A2 and of A3. Preferably such further anthocyanins or anthocyanidins, if present are altogether present in proportions (based on the total amount of anthocyanins and anthocyanidins) lower than the total proportion of A1, A2 and A3. Such further anthocyanins or anthocyanidins preferably altogether represent less than 25% by weight, preferably less than 10% by weight, preferably less than 5% by weight of the total amount of anthocyanins and anthocyanidins.

It is mentioned that the dairy product might comprise an association of several strawberry varieties meeting the features of the strawberry of the invention. It is mentioned that the dairy product might comprise at least one variety meeting the features of the strawberry of the invention, and at least one variety that does not meet the features of the strawberry of the invention (referred to as “further strawberry”). Preferably the proportion by weight of the strawberry of the invention, compared to all the strawberries (strawberry of the invention and further strawberry), is of higher than 33%, preferably higher than 50%, preferably higher than 66%. In one embodiment all the strawberries, either strawberries of the invention and/or further strawberries, are present in amounts such that a virtual strawberry having A1, A2 and A3 in proportions corresponding to the mixture, would meet the features the strawberry of the invention.

The strawberry can be present in the dairy product in the form of integral strawberry fruit, strawberry fruit pieces, strawberry fruit puree and/or strawberry fruit preparation.

### Dairy Product

The dairy product of the invention is typically in the form of a dairy mass (also referred to as white mass), wherein the strawberry is dispersed. It can be for example dispersed as integral strawberry fruits, as strawberry fruit pieces, strawberry fruit puree and/or fruit preparation. By dispersion it is meant that the strawberry (in any from) is surrounded by the dairy mass, as inclusions. The dairy mass is the constituent of the dairy product, without the fruit component or preparation. Hereafter the dairy mass and the dairy product might however be described similarly.

The dairy product or mass is typically comprised of milk and/or ingredients obtained from milk. It is also referred to as a “milk-based composition”. Herein milk encompasses also substitutes to animal milk, such as vegetal milk, such as soy milk, rice milk, etc.

Milk-based compositions useful in such products and/or processes are known by the one skilled in the art of dairy products, preferably fermented dairy products. Herein a milk-based composition encompasses a composition with milk or milk fractions, and compositions obtained by mixing several previously separated milk fractions. Some water or some additives can be added to said milk, milk fractions and mixtures. Herein milk typically refers to animal milk, for example cow milk. Some alternative animal milks can be used, such as sheep milk or goat milk.

The milk-based composition can typically comprise ingredients selected from the group consisting of milk, half skimmed milk, skimmed milk, milk powder, skimmed milk powder, milk concentrate, skim milk concentrate, milk proteins, cream, buttermilk and mixtures thereof. Some water or additives can be mixed therewith. Examples of additives that can be added include sugar, sweeteners different from sugar, fibers, and texture modifiers. The milk-based composition can typically have a fat content of from 0% to 5% by weight, for example of from 0% to 1% or from 1% to 2% or from 2% to 3% or from 3% to 4% or from 4% to 5%. The “fat content” of a product corresponds to the weight of the fat components present in the product relatively to the total weight of the product. The fat content is expressed as a weight percentage. The fat content can be measured by the Weibull-Berntrop gravimetric method described in the standard NF ISO 8262-3. Usually the fat content is known for all the ingredients used to prepare the product, and the fat content of the product is calculated from these data.

The milk-based composition can typically have a protein content of from 2% to 6% by weight, for example of from 2% to 3% or from 3% to 4% or from 4% to 5% or from 5% to 6%. The “protein content” of a product corresponds to the weight of the proteins present in the product relatively to the total weight of the product. The protein content is expressed as a weight percentage. The protein content can be measured by Kjeldahl analysis (NF EN ISO 8968-1) as the reference method for the determination of the protein content of dairy products based on measurement of total nitrogen. Nitrogen is multiplied by a factor, typically 6.38, to express the results as total protein. The method is described in both AOAC Method 991.20 (1) and international Dairy Federation Standard (IDF) 20B:1993. Usually the protein content is known for all the ingredients used to prepare the product, and the protein content of the product is calculated from these data.

The ingredients of the milk-based composition and/or the amounts thereof can be selected thereto.

The dairy product or mass can be for example:
a fermented milk product, for example a yogurt, a fresh cheese, a cheese,
a non-fermented milk-based dessert,
a vegetal milk substitute, for example soy milk, rice milk, oat milk, almond milk or a mixture thereof,
a fermented vegetal milk substitute product, for example a fermented soy product,
a non-fermented vegetal milk substitute dessert, for example a soy dessert,
a frozen dessert, for example an ice-cream, or a frozen yogurt.

In a preferred embodiment the dairy product is a fermented milk product with strawberry.

The dairy product can be in the form of a liquid drink, a viscous spoonable product, a mousse, or a solid product such as a frozen product. Such dairy products are known by the one skilled in the art.

Desserts, either milk-based or vegetal milk substitute-based are typically heat-treated products, usually comprising gelling agents. They can be for example in the form of a flan, a gel, a creme or a mousse.

The dairy product or mass can be a fermented milk product, or a fermented vegetal milk substitute product. Fermented products typically comprise microorganisms, such as lactic acid bacteria and/or probiotics (the probiotics can be lactic acid bacteria), dead or alive. These are also referred to as ferments or cultures or starters. Lactic acid bacteria are known by the one skilled in the art. They include Lactobacilli (Lactobacillus acidophilus, Lb. casei, Lb. plantarum, Lb. reuteri, Lb. johnsonii), certain Streptococci (Streptococcus thermophilus), Bifidobacteria (Bifidobacterium bifidum, B. longum, B. breve, B. animalis) and/or Lactococci (Lactococcus lactis). Probiotics are also known by the one skilled in the art. Examples of probiotics include some Bifidobacteria and Lactobacilli, such as Bifidobacterium brevis, Lactobacillus acidophilus, Bifidobacterium animalis, Bifidobacterium animalis lactis, Bifidobacterium infantis, Bifidobacterium longum, Lactobacillus casei, Lactobacillus casei paracasei, Lactobacillus reuteri, Lactobacillus plantarum, or Lactobacillus rhamnosus. In one embodiment the product is a fermented milk product such as yogurt. It is mentioned that yogurts are considered as being specific fermented milk products.

Fermented products have undergone a fermentation step. The fermentation is typically done by microorganisms such as bacteria and/or yeasts, preferably at least bacteria, preferably lactic acid bacteria, and leads to the production of fermentation products, for example lactic acid, and/or to the multiplication of the microorganisms. The designation “fermented milk” can depend on local legislation, but is typically given to a dairy product prepared from skimmed or full fat milk, or concentrated or powdered milk, having undergone a heat treatment at least equivalent to a pasteurization treatment, and inoculated with lactic acid producing microorganisms such as the bacteria mentioned above.

If the dairy product is a fermented dairy product, it typically comprises lactic acid bacteria. The lactic acid bacteria typically comprise a mixture of Streptococcus thermophilus and Lactobacillus delbrueckii subsp. Bulgaricus.

The fermented milk product can be a set product, wherein fermentation occurs in the packaging, or a stirred or drink product, wherein fermentation occurs in a tank, prior to adding fruit preparations and stirring to lower the viscosity and to pack.

Fermented milk products, before the addition of the composition of the invention, can be referred to as “white masses”. The pH of the white mass and/or of the final food product can be for example of from 3.5 to 5, preferably from 4 to 5, preferably from 4.2 to 4.9.

The dairy product can typically comprise from 1% to 25% by weight, preferably from 5 to 20%, of strawberry, preferably of the strawberry of the invention. The strawberry can be introduced via an intermediate more concentrated preparation, typically a fruit preparation. Such preparations are further described below.

The dairy product might comprise some additives, such as organoleptic modifiers, viscosity and/or texture agents. The dairy product is preferably substantially free of colorant. It is however not excluded that the dairy product comprise some colorant, preferably in lower amounts than in similar products based on strawberries different from strawberries of the invention. Typically, the higher the amount of strawberry according to the invention is, the lower the amount of colorant(s) is.

In one embodiment the dairy product comprises the strawberry of the invention, substantially no further strawberry, and substantially no colorant.

In one embodiment the dairy product comprises the strawberry of the invention, some further strawberry, and substantially no colorant or a lower amount of colorant.

### Fruit Preparation

The dairy product of the invention comprises the strawberry. The strawberry can be typically introduced in the product by mixing a dairy mass with the strawberry, typically in the form of a fruit preparation. Such introductions and preparations are known by the one skilled in the art. In the fruit preparation the fruit is the strawberry. In some embodiment the fruit preparation comprises further different fruits. Typically a fruit preparation can be added in an amount of 5-35% by weight with reference to the total amount of product. In a particular embodiment the fruit preparation is substantially free of colorant(s).

The fruit preparation typically comprises a stabilizing system, having at least one stabilizer. The stabilizing system can comprise at least two stabilizers. Such stabilizers are known by the one skilled in the art. They typically help in avoiding phase separation of solids, for examples of fruits or fruits extracts and/or in avoiding syneresis. They typically provide some viscosity to the preparation, for example a viscosity (Bostwick viscosity at 20° C.) of from 1 to 20 cm/min, preferably of from 4 to 12 cm/min. The stabilizing system or the stabilizer can for example be a starch, a pectin, a guar, a xanthan, a carrageenan, a locust bean gum, or a mixture thereof. The amount of stabilizing system is typically of from 0.5 to 5% by weight.

The fruit preparation can typically comprise organoleptic modifiers. Such ingredients are known by the one skilled in the art.

The organoleptic modifiers can be for example sugars, sweetening agents different from sugar, coloring agents, cereals and/or cereal extracts, or flavors.

Examples of sweetening agents are ingredients referred to as High Intensity Sweeteners, such as sucralose, acesulfamK, aspartam, saccharine, rebaudioside A or other steviosides or stevia extracts.

The strawberry fruit can be for example provided for the preparation as:
frozen fruit cubes, for example 10 mm fruit cubes, for example Individual Quick Frozen fruit cubes,
Aseptic fruit cubes, for example 10 mm fruit cubes,
fruit purees, for example fruit purees concentrated from 2 to 5 times, preferably 3 times, for example aseptic fruit purees,
single aseptic fruit purees,
frozen whole fruits, for example Individual Quick Frozen whole fruits,
mixtures thereof. The ingredients and/or components of the fruit preparation and the amounts thereof are typically such that the preparation has a brix degree of from 1 to 65 brix, for example from 1 to 10 brix, or from 10 to 15 brix, or from 15 to 20 brix, or from 20 to 25 brix, or from 25 to 30 brix, or from 30 to 35 brix, or from 35 to 40 brix, or from 40 to 45 brix, or from 45 to 50 brix, or from 50 to 55 brix, or from 55 to 60 brix, or from 55 to 60 brix, or from 60 to 65 brix.

The fruit preparation can for example comprise strawberry fruit in an amount of from 30% to 80% by weight, for example from 50 to 70% by weight.

The fruit preparation can comprise water. It is mentioned that a part of the water can come from ingredients used to prepare the fruit preparation, for example from fruits or fruit extracts or from premix solutions.

The fruit preparation can comprise pH modification agents such as citric acid.

### Processes

The dairy product can be prepared according to any appropriate process involving the strawberry of the invention. An appropriate process for example comprises a step of mixing a dairy mass and the strawberry of the invention. As already mentioned above, the strawberry is preferably mixed in the form of a fruit preparation.

The mixing can for example involve:
1-25% by weight, preferably 5-20%, of fruit preparation comprising the strawberry, and
75-99% by weight, preferably 80-95%, of dairy mass.

The fruit preparation can be prepared by conventional processes. Such processes preferably involve a step of heating the fruits, to allow pasteurization.

The dairy mass can be prepared by conventional processes. Such processes preferably involve a fermentation step in the presence of lactic acid bacteria. Examples of processes comprise the steps of:
Step a) providing a milk-based composition,
Step b) inoculating a starter culture,
Step c) allowing a fermentation, and
Step d) recovering a dairy mass (fermented dairy mass).

Step a) can comprise sub-steps such as heat-treatments, for example pasteurization or sterilization, and/or homogenization. Such steps are known be the one skilled in the art.

Step a) can be performed using conventional equipments such as mixing equipments, heat exchangers, and homogenizers.

In a particular embodiment step a) comprises the following steps:
step a1) mixing ingredients to provide the milk-based composition,
step a2) pasteurizing at a temperature of at least 90° C.,
step a3) homogenizing and cooling to a temperature of less than 50° C.

Step a) can comprise a homogenization step. This is preferably carried out at step a3). Such operations are well known by the one skilled in the art and can be performed with conventional equipments. The homogenization can be performed at a pressure of at least 25 bars. In a particular embodiment, the homogenization phase is performed at a pressure of at least 100 bars. It is mentioned that the homogenization can be performed in two steps: one at a pressure of 100-200 bars, one at a pressure of 25-50 bars.

Step a) can comprise a heat treatment, such as pasteurization, Ultra High Temperature treatment, or High Temperature treatment. This is preferably carried out at step a2). Such treatments are known by the one skilled in the art, and can be performed with conventional equipments. The heat treatment is typically operated at least 90° C. Depending on the temperature the treatment time can last typically from 1s to 20 minutes.

Step a) can comprise a step of placing the mixture to a fermentation temperature, typically comprised between 30 and 50° C., preferably of 35° C. to 45° C. This is typically done by cooling after a heat treatment. This can be done for example at step a3).

Step b) involves inoculating a starter culture in the milk-based composition. Such an operation is known by the one skilled in the art. Inoculation can be typically performed at a rate of from 0.002 to 0.2% by weight, for example from 0.002% to 0.01% or from 0.01% to 0.05% or from 0.05% to 0.2%. The starter culture preferably comprises a mixture or association of Streptococcus thermophilus and Lactobacillus delbrueckii ssp. Bulgaricus lactic acid bacteria.

Step c) involves allowing a lactic fermentation. This is typically done at a temperature of higher than 30° C. This step is also referred to as a fermentation step. Step c) leads to a composition referred to as white mass.

Fermentation operations are known by the one skilled in the art. Fermentation can be typically performed at a temperature between 30° C. and 50° C., preferably from 35° C. to 45° C. Fermentation can be stopped by cooling and/or breaking the mixture when a breaking pH is reached. The fermentation time is the time between the inoculation and the breaking and/or cooling. The fermentation time can depend on the lactic acid bacteria, on the amount thereof, and on the temperature, and can for example last from 3 hours to 30 hours, for example from 12 to 22 hours.

During fermentation, the pH of the mixture decreases with production of lactic acid by the bacteria. The pH at the end of the fermentation can be typically of 5 or less than 5, preferably of from 3.5 to 4.6. In a preferred embodiment the fermentation is carried out to a pH of from 3.5 to 5 preferably from 4.5 to 4.9.

After fermentation, step c) can comprise a further step of stirring to obtain a composition having a desired viscosity. Such a step can be performed for example with a smoothing valve, for example at a pressure of at least 1.5 bars, or with a static mixer or with a dynamic mixer. This step provides some shear to composition that typically allow a viscosity drop and/or a reduction of grains. Such operations are known by the one skilled in the art, and can be operated with conventional appropriate equipments. This step is typically performed at cold temperature, for example at a temperature of from 1° C. to 25° C. It is mentioned that this stirring step is not performed in the case of set products, wherein fermentation is performed in packaging.

In step d) the dairy mass is recovered. The dairy mass is typically mixed with further ingredients and/or components including the strawberry, preferably in the form of a fruit preparation. The mixture is typically transferred to a container.

### Packaging

The dairy product is typically conditioned by filling in a container, such as a cup or a bottle, and then sealing, to obtain a finish product. Sealing can be performed for example with a cap or with a lid. The container can be for example a container of 50 ml (or 50 g), to 1 L (or 1 kg), for example a container of 50 ml (or 50 g) to 80 ml (or 80 g), or 80 ml (or 80 g) to 100 ml (or 100g), or 100 ml (or 100 g) to 125 ml (or 125 g), or 125 ml (or 125 g) to 150 ml (or 150 g), or 150 ml (or 150 g) to 200 ml (or 200 g), or 200 ml (or 200 g) to 250 ml (or 250 g),or 250 ml (or 250 g) to 300 ml (or 300 g), or 300 ml (or 300 g) to 500 ml (or 500 g), or 500 ml (or 500 g) to 750 ml (or 750 g(, or 750 ml (or 750 g) to 1 L (or 1kg).

The dairy product can be stored, transported and/or distributed at a chilled temperature of 0° C. to 10° C., preferably of 4° C. to 10° C., for example from 4° C. to 8° C.

### Uses

The invention also concerns the use of the strawberry of the invention in dairy products. The use is typically a use for improving coloration, preferably chroma.

The dairy product is typically to be used as a food product. It is typically used by oral administration. One can typically eat or drink the composition by processing it from a container to the mouth, optionally using a spoon, a glass, or a straw. The container is preferably a cup.

Further details or advantages of the invention might appear in the following non limitative examples.

### EXAMPLES

### Example 1

### Strawberries Anthocyanins Analysis

The anthocyanins composition of the following strawberries varieties is evaluated, according to the analysis protocol provided below:
Strawberry 1 (comparative): Camarossa standard whole in 10 mm cubes
Strawberry 2 (comparative): Camino Real whole in 10 mm cubes
Strawberry 3: DipRed in 10mm whole in 10 mm cubes, supplied by Mazzoni.
Strawberry 4 (Comparative): Senga Sengana whole in 10 mm cubes
Strawberry 5 (Comparative): US13 whole in 10 mm cubes

The results are reported on table 1.

### Analysis Protocol

Prior to analysis the anthocyanins are extracted from strawberries with methanol as follows: weigh 1 g of crushed strawberries or 10 g of crushed dairy product, mix with 40 mL of methanol and put in an ultrasonic bath for 30 minutes. The mixture is centrifuged (5000×g, 15 min, 10° C.) and the supernatant is filtrated on 0.45 μm sieve.

The analysis of anthocyanins in strawberries is performed on high performance liquid chromatography (HPLC) coupled to photodiode array (PDA) and electrospray ionization mass spectrometry (Quattro Ultima Platinum—Waters) in positive ion mode (ESI+-MS) for the three anthocyanins: Cy3G (m/z 448.9), Pg3G (m/z 432.9) and Pg3MG (m/z 518,9).

HPLC is performed on a C18 column (250×2 mm, 5 μm, Nucleodur macherey-nagel). The mobile phase consists of two solvents: water/formic acid 99/1 (A) and methanol/formic acid 99/1 (B), at a flow rate of 0.2 mL/min and the injection volume 20 μL. The linear gradient (46 min) consists of 80% (A) and 20% (B) to 100% (B) in 30 min. The column is maintained at 30° C.

The following ESI source parameters are implemented: cone gas 125 L/h, flow gas for desolvatation 430 L/h, capillary 2.8 kV, cone voltage 40V,source temperature 120° C., desolvatation temperature 430° C. Used mode is SIR (Selecting Ion Recording).

The results are reported as an average of 2 analyses of 3 extracts per strawberry sample.

TABLE 1

| | | Strawberry | | |
|---|---|---|---|---|
| | | Strawberry 1 | Strawberry 2 | |
| | | (comparative) | (comparative) | Strawberry 3 |
| | | Name | | |
| | | Camarossa | Camino Real | DipRed/Deep Ruby |
| A1: Cy3G | mg/kg | 20.0 | 28.0 | 17.6 |
| | % | 5.59% | 5.98% | 2.38% |
| A2: Pg3G | mg/kg | 337.8 | 439.8 | 444.6 |
| | % | 94.41% | 94.02% | 60.11% |
| A3: Pg3MG | mg/kg | 0 | 0 | 277.4 |
| | % | 0% | 0% | 37.51% |
| A1 + A2 + A3 | mg/kg | 357.8 | 467.9 | 739.6 |

| | | Strawberry | |
|---|---|---|---|
| | | Strawberry 4 | Strawberry 5 |
| | | (comparative) | (comparative) |
| | | Name | |
| | | Senga Sengana | US13 |
| A1: Cy3G | mg/kg | 22.3 | 13.0 |
| | % | 3.89% | 3.55% |
| A2: Pg3G | mg/kg | 488.1 | 295.7 |
| | % | 85.21% | 80.68% |
| A3: Pg3MG | mg/kg | 62.4 | 57.8 |
| | % | 10.89% | 15.77% |
| A1 + A2 + A3 | mg/kg | 572.8 | 366.5 |

### Example 2

### Strawberries Coloration

The coloration of the strawberries is analyzed according to L*, C*, h° cylindrical coordinates, according to the protocol provided below. L* represents lightness (the higher the lighter, the lower the darker). C* represents the chroma (the higher the brighter, the lower the duller). h° represents the hue (color tonality on the chromatic circle).

Coloration Analysis Protocol

Coloration analysis is performed with Datacolor Check apparatus, using the parameters and features below. The results are reported on table 2 as an average of 2 measures on 3 samples.

Samples Preparation

For strawberry analysis the strawberry is unfrozen and crushed with an Ultraturax® apparatus to obtain a homogeneous puree. For dairy product, the product is crushed with an Ultraturax® apparatus to obtain a homogeneous sample.

Analysis
Illuminant : DE65, UV inclus (lumière du jour standard).
Observator: 10° (observateur standard).
Specular port: included (shiny aspect included) in DE_{CMC} definition L=2, C=1 DE_{CMC 2:1}.
Aperture size: 15 mm (LAV).
Calibration once every 8 hours with check by measurement of a green standard with known L*C*h° values.
Samples analyzed in a closed Petri Dish.

Results:

| | Strawberry | | |
|---|---|---|---|
| | Strawberry 1 | Strawberry 2 | |
| | (comparative) | (comparative) | Strawberry 3 |
| | Name | | |
| | Camarossa | Camino Real | DipRed/Deep Ruby |
| L* | 36.32 | 35.57 | 34.05 |
| C* | 19.83 | 18.74 | 16.92 |
| h* | 18.93 | 17.05 | 15.93 |

| | Strawberry | |
|---|---|---|
| | Strawberry 4 | Strawberry 5 |
| | (comparative) | (comparative) |
| | Name | |
| | Senga Sengana | US13 |
| L* | 36.56 | 37.61 |
| C* | 23.16 | 22.64 |
| h* | 20.77 | 21.43 |

### Example 3

### Analysis of Dairy Products Comprising Strawberries

Dairy products are prepared by mixing:
18% by weight of a fruit preparation comprising the strawberry (corresponding to 10% of strawberry)—Composition and preparation process are detailled below.
82% by weight of a white mass—detailled below.

The coloration of the dairy products is evaluated according to the analysis protocol as above. The results are presented on table 4.

Fruit Preparation

The fruit preparations detailed in table 3 are prepared. The preparation protocol is the following:
Frozen fruits are pre-heated at 58-60° C. in a saucepan provided with agitating blades
Stabilizers are added in a pre-hydrated form with some of the water
the mixture is pasteurized at 90° C. during 5 minutes, then cooled to 10° C. The other ingredients (sweeteners, flavors, processing aids, remainder of water) are added during cooling, at a temperature of about 70° C.

TABLE 3

| | Strawberry 1 (comparative) | | Strawberry 2 (comparative) | |
|---|---|---|---|---|
| Type of | Camarossa | | Camino Real | |
| ingredient | Ingredient | % | Ingredient | % |
| Strawberry | Strawberry 1 Cubes | 55.60 | Strawberry 2 Cubes | 55.60 |
| | 10 mm IQF | | 10 mm IQF | |
| Sweetener | Saccharose | 20.00 | Saccharose | 20.00 |
| Stabilizer(s) | Starch E1422 | 1.10 | Starch E1422 | 1.10 |
| | Pectine | 0.45 | Pectine | 0.45 |
| Flavor | Proprietary | 0.31 | Proprietary | 0.31 |
| Processing aids | Citric acid, Tricalcium | 0.16 | Citric acid, Tricalcium | 0.16 |
| | dicitrate, sodium | | dicitrate, sodium citrate, | |
| | citrate, Potassium | | Potassium sorbate | |
| | sorbate | | | |
| Water | Water | 22.38 | Water | 22.38 |
| | pH | 3.78 | pH | 4.00 |
| | Brix | 23.6 | Brix | 26.0 |

| | Strawberry 3 | |
|---|---|---|
| Type of | Dipred/Deep Ruby | |
| ingredient | Ingredient | % |
| Strawberry | Strawberry 3 Cubes | 55.60 |
| | 10 mm IQF | |
| Sweetener | Saccharose | 20.00 |
| Stabilizer(s) | Starch E1422 | 1.10 |
| | Pectine | 0.45 |
| Flavor | Proprietary | 0.31 |
| Colorants | Carmine 4% | 0 |
| Processing aids | Citric acid, Tricalcium | 0.16 |
| | dicitrate, sodium citrate, | |
| | Potassium sorbate | |
| Water | Water | 22.38 |
| | pH | 3.89 |
| | Brix | 27.0 |

White Mass

The white mass is stirred fermented milk product having the following features:
added sugar: 4.8%
proteins: 4%
fat: 4%
pH: 4.5.

TABLE 4

| | Strawberry | | |
|---|---|---|---|
| | Strawberry 1 | Strawberry 2 | |
| | (comparative) | (comparative) | Strawberry 3 |
| | Name | | |
| | Camarossa | Camino Real | DipRed/Deep Ruby |
| L* | 86.4 | 84.9 | 81.7 |
| C* | 8.25 | 8.61 | 9.54 |
| h* | 50.99 | 39.69 | 25.69 |

The evolution of coloration between the strawberry fruit (table 2) and the dairy product (table 4) is presented in table 5 below, reporting the value (final-initial)/initial.

TABLE 5

| | Strawberry | | |
|---|---|---|---|
| | Strawberry 1 | Strawberry 2 | |
| | (comparative) | (comparative) | Strawberry 3 |
| | Name | | |
| | Camarossa | Camino Real | DipRed/Deep Ruby |
| L* evolution | +137.89% | +138.68% | +139.94% |
| C* evolution | −58.40% | −54.06% | −43.62% |
| h* evolution | +169.36% | +132.79% | +61.27% |

| | Strawberry | |
|---|---|---|
| | Strawberry 4 | Strawberry 5 |
| | (comparative) | (comparative) |
| | Name | |
| | Senga Sengana | US13 |
| L* evolution | +132.17% | +131.37% |
| C* evolution | −66.06% | −66.65% |
| h* evolution | +99.47% | +198.93% |

Strawberry 3 has less loss of chroma after introduction in the dairy product than comparative strawberries 1, 2, 4 and 5.

Strawberry 3 has less variation of hue h° after introduction in the dairy product than comparative strawberries 1, 2, 4 and 5.

### Example 4

### Recipes

Dairy products are prepared by mixing fruit preparations and white masses in proportions shown in table 6 below.

TABLE 6

| | Example 3.2a | | Example 3.2b | |
|---|---|---|---|---|
| Fruit Preparation | Example 3.1a | 10% | Example 3.1b | 20% |
| Whit Mass | White Mass a | 90% | White Mass b | 80% |

Fruit Preparations

The fruit preparations on table 7 below are prepared, using strawberry 3 in the form of 10 mm IQF cubes, or in the form of a puree, obtained by milling the cubes.

TABLE 7

| | Preparation 3.1a | | Preparation 3.1b | |
|---|---|---|---|---|
| Type of ingredient | Ingredient | % | Ingredient | parts |
| Fruits | Strawberry 3 puree | 32.58 | Strawberry 3 Cubes 10 mm | 60.00 |
| | (33% strawberry- | | IQF | |
| | 67% water) | | 5.6 Lemon juice concentrate | 0.21 |
| Sweetener | Saccharose | 28.00 | a) Sucralose | a) 0.042 |
| | | | b) Acesulfam K | b) 0.053 |
| | | | c) Polydextrose sirup | c) 12.49 |
| | | | (brix 70) | |
| Stabilizer(s) | Starch E1422 | 4.70 | a) Starch 1442 | a) 2.40 |
| | | | b) Carrageenan | b) 0.30 |
| | | | c) Xanthan gum | c) 0.10 |
| Flavors | Proprietary | 0.55 | Proprietary | 0.325 |
| Processing aids | Citric acid | 0.03 | Calcium Chloride, Enzymes, | 1.12 |
| | | | citric acid, sodium citrate | |
| Water | Water | 34.14 | Water | 22.96 |
| | pH | 3.80 | pH | 3.9 |
| | Brix | 37 | Brix | 15 |

White Masses

The white masses are stirred fermented milk product having the following features:

| | White Mass a | White Mass b |
|---|---|---|
| Added | 6% | 6% |
| Sugar | | |
| Proteins | 3.8% (from Milk) | 5.1% (from Milk, Skim Milk |
| | | Powder, Milk Protein Isolate) |
| Fat | 3.2% | 0% |
| pH | 4.45 | 4.46 |

Observations—Evaluations

The dairy products of examples 3.2a and 3.2b are visually evaluated for color. They present red coloration, considered as bright, equivalent to similar products obtained with different strawberries but with addition of colorants in fruit preparation (0.27% of a 4% Carmine solution).

1-20. (canceled)

21. A dairy product comprising some strawberry having anthocyanins comprising the following three specific anthocyanins:
A1: Cyanidin-3-Glucosid (Cy3G),
A2: Pelargonidin-3-Glucosid (Pg3G), and
A3: Pelargonidin-3-Malonylglucosid (Pg3MG),
wherein the weight ratio A3/(A1+A2+A3) is at least 0.20.

22. The product according to claim 21, wherein the weight ratio A3/A2 is at least 0.15.

23. The product according to claim 21, wherein the following conditions are satisfied:
weight ratio A1/(A1+A2+A3) is from higher than 0 to 0.1,
weight ratio A2/(A1+A2+A3) is from 0.48 to 0.62,
weight ratio A3/(A1+A2+A3) is from 0.25 to 0.5, and
the total of the weight ratios is 1.

24. The product according to claim 21, wherein the strawberry has a total concentration of A1, A2 and A3 of at least 400 mg/kg.

25. The product according to claim 21, wherein the strawberry is selected from the following varieties: Deep Ruby, DipRed, Rubydee, Rubinociv, Rubino and mixtures thereof.

26. The product according to claim 21, wherein the strawberry is selected from varieties covered by and/or described in the following plants breeder's rights:
European Union application 20121736 filed Aug. 9 2012, and/or
European Union application 20121735 filed Aug. 9 2012.

27. The product according to claim 21, wherein the strawberry is in the form of integral strawberry fruit, strawberry fruit pieces, strawberry fruit puree and/or strawberry fruit preparation.

28. The product according to claim 21, being in the form of dairy mass wherein the strawberry is dispersed.

29. The product according to claim 21, wherein the product or mass is comprised of milk and/or ingredients obtained from milk.

30. The product according to claim 21, being a fermented milk product with strawberry.

31. The product according to claim 21, being substantially free of colorant.

32. The product according to claim 21, comprising from 1% to 25% by weight of the strawberry.

33. The product according to claim 21, having a total concentration of A1, A2 and A3 of at least 40 mg/kg.

34. A process for preparing a product according to claim 21, comprising a step of mixing a dairy mass and some strawberry having anthocyanins comprising the following three specific anthocyanins:
A1: Cyanidin-3-Glucosid (Cy3G),
A2: Pelargonidin-3-Glucosid (Pg3G), and
A3: Pelargonidin-3-Malonylglucosid (Pg3MG),
wherein the weight ratio A3/(A1+A2+A3) is at least 0.20.

35. The process according to claim 34, wherein the dairy mass comprises milk and/or ingredients obtained from milk.

36. The process according to claim 34, wherein the dairy mass is a fermented milk product.

37. The process according to claim 34, wherein the strawberry is mixed in the form of a fruit preparation.

38. The process according to claim 37, wherein the mixing involves:
1-25% by weight of fruit preparation comprising the strawberry, and
75-99% by weight of dairy mass.

39. A method for improving coloration of a dairy product containing strawberry comprising preparing said dairy product with some strawberry having anthocyanins comprising the following three specific anthocyanins:
A1: Cyanidin-3-Glucosid (Cy3G),
A2: Pelargonidin-3-Glucosid (Pg3G), and
A3: Pelargonidin-3-Malonylglucosid (Pg3MG),
wherein the weight ratio A3/(A1+A2+A3) is at least 0.20.

40. The method according to claim 39, wherein the chroma of the dairy product is improved.

41. The product according to claim 21, wherein:
the weight ratio A3/(A1+A2+A3) is at least 0.30,
the weight ratio A3/A2 is at least 0.5, and
the total concentration of A1, A2 and A3 of said product is of at least 70 mg/kg.

42. The product according to claim 21, wherein the strawberry:
has a total concentration of A1, A2 and A3 of at least 700 mg/kg, and
represents 5% to 20% by weight of the product.
